(19) United States
(12) Patent Application Publication
(10) Pub. No.: US 2004/0147244 A1
(43) Pub. Date: Jul. 29, 2004

(54) Method, device and system to show heading in a cellular network

(76) Inventor: Veikko Lauri Raisanen, Nokia (FI)

Correspondence Address: STITES & HARBISON PLLC, 1199 NORTH FAIRFAX STREET, SUITE 900, ALEXANDRIA, VA, 22314, US

(21) Appl. No.: 10/476,641

(22) PCT Filed: May 3, 2002
(86) PCT No.: PCT/FI02/00376

(30) Foreign Application Priority Data
May 4, 2001 (FI) 20010930

(51) Int. Cl. H04Q 7/20

(52) U.S. Cl. 455/404.2; 455/456.1

(57) ABSTRACT

This invention relates to a method, a device and a system for indicating the direction to the desired point in a cellular network in which base stations transfer communication and form cells, and in which base stations communicate with the mobile transceivers within the cell area. According to the method the direction to a desired location is calculated as a network service on the basis of the transceiver's (1) defined location in relation to the direction of the earth's magnetic field, and this direction being sent as a message from the base station to the transceiver that is equipped with a detector (5) that indicates the direction of the earth's magnetic field. According to the invention based on the directional information contained in the sent message and the direction of the transceiver the direction to the desired location is shown on the display (7) of the transceiver. In the device according to the invention the transceiver (1) is equipped with a detector (5) detecting the direction of the earth's magnetic field and with a data processing unit (6) for processing directional information and for showing the direction (8) on a display (7). The system according to the invention consists of those functions by which the directional information by request is delivered to the customer. With the aid of this invention resting on the operation of a cellular network the direction to a desired point can be shown user-friendly while the direction of the earth's magnetic field is used as the reference direction.

### AREA OF APPLICATION

A method for indicating the direction to the desired point in a cellular network in which base stations transfer communication and form cells, and in which base stations communicate with the mobile transceivers, provided with display, within the cell area, and the said method being used for defining the location of the transceiver within the cellular network area.

A device for indicating the direction to the desired point in a cellular network, with the said device incorporating a display for indicating the direction and a transceiver for communicating with a base station and for receiving directional information from the base station.

Furthermore, the invention encompasses a system for defining the directional information and forwarding it to the customer's transceiver as network service within the cellular network.

### PRIOR ART AND ITS DEFECTS

A cellular network means a radio network with its operation based on the specific coverage areas of base stations. The coverage area of a single frequency, a channel, is called a cell. A single base station may constitute one or more cells depending on the way in which the base station is connected to the aerial interface. One omni directional antenna can constitute one cell for the station point of a base station. On the other hand, several sectorized cells can be constituted for the station point of a base station by using directional antennas. The structure, operation, and design principles of a cellular network are, as such, self-evident to those ordinary skilled in the art and, thus, they are not explained in any greater detail in this application. A cellular network incorporates several properties and services developed for this system. An example of these is the follow-up of the location of a mobile phone within the network area. Based on a cellular network, however, no such arrangement exists that would enable a service provided from a network through a mobile phone and directing to a desired location. Later in this application, the term network is used for denoting a cellular network or a radio network in general.

There are several different devices and methods for the purposes of indicating direction and positioning. These include the normal compass that measures the direction of the earth's magnetic field, as well as devices and methods relying on the GPS system. A compass is an inexpensive and convenient device for determining the direction to a desired location. However, to use a compass you need a map and also some special skills. Based on satellites orbiting the earth, the operation of GPS equipment is developed for determining a position. Positioning is based on satellites located on orbits and constantly transmitting to the earth very accurate time data and information on their own position. On the basis of the messages it receives a receiver on the earth is able to detect how long the signal from each satellite has travelled, and this information enables it to calculate its exact position in relation to the satellites.

Information from just one or two satellites is not yet sufficient for positioning. It is not until at least four suitable satellites are simultaneously “visible” that the exact position of a single receiver can be calculated.

As the GPS signals come from much greater distances than the nearest radio tower they are weaker, and also their wavelength is such that they are practically “inaudible” indoors. Satellite positioning is not possible through any obstacles thicker than window glass.

This system does not indicate the direction to a desired point, and it also requires open space for its operation. For this reason, problems arise in the use of the GPS system in urban areas where buildings form obstacles to the satellite signals.

The U.S. Pat. No. 6,127,945 patent publication presents a positioning device and method where position coordinates of certain locations are fed into the device through, for instance, a radiotelephone network. The position coordinates of the device are determined using, for instance, the GPS. The calculating unit of the device determines the position of the device in relation to the desired location and shows the locations in question on the display of the device.

In this example, the radiotelephone network is not utilized in any other way than for feeding the position coordinates of the locations to the device. The described system method shows the device's direction of movement on the display, but not the direction to the desired point.

In conjunction with portable phones and the networks transferring the calls even the authorities have expressed the need for locating a portable phone in case of emergency, for instance. Various means of locating a phone within a network have been presented. One method is to simultaneously determine the distance of the portable phone to two or more base stations. The position coordinates of the phone can be determined as the crossing points of these distances when the coordinates of the base stations are known.

An example of how to determine the distance between a mobile phone and a base station is presented in the U.S. Pat. No. 6,181,944 patent publication, where the distance between a radiophone and a base station is determined on the basis of the phase shifts between exchanged messages.

In the U.S. Pat. No. 6,167,276 patent publication the distance between a base station and a radiophone is determined using the absolute time common to the phone and the base station and determined by the base station. By also determining the exact time delay required for the phone to send the reply message it is possible to determine the distance with the desired accuracy.

The U.S. Pat. No. 6,154,657 patent publication presents some means for determining the location of a phone in a cellular network. The presented means are: the time from transmission to reception, the difference in times between transmission and reception at two different base stations, and measuring the angle from the base station to the phone.

The prior art solutions aim at determining the position of a mobile phone as precisely as possible. The position data of a mobile phone provided by the network is useful for rescue purposes in, for instance, emergency situations. From the mobile phone user's point of view, this kind of position monitoring works ‘outwards’, without the user's consent or knowledge. It is even possible that some users may feel uncomfortable with this type of surveillance under normal circumstances.

For the average mobile phone user position data, even if received as coordinates, would be meaningless without a map for locating the coordinates to the environment. It would be more interesting for the mobile phone user to know the direction from his/her present location to a desired location. Compared with mere position data, directional information is always in such a relation to the surroundings of the mobile phone user that it offers him/her real practical benefits.

### THE PURPOSE OF THE INVENTION

The purpose of this invention is to create a new, improved, and user-friendly solution for indicating the direction to a desired location, utilizing the cellular network used for mobile phone communication.

The method pursuant to the invention is characterized by the direction to a desired point in relation to the earth's magnetic field being calculated on the basis of the transceiver's defined location and the direction of the earth's magnetic field corresponding to that location, and this direction being given as a message sent by a base station to the transceiver that is provided with a sensor for detecting the direction of the earth's magnetic field and that, with the information of the transceiver's direction in relation to the earth's magnetic field and the directional information of the sent message, shows on the display the direction to the desired location.

In addition, the device for indicating direction pursuant to the invention is characterized by an incorporated sensor for detecting the direction of the earth's magnetic field, and a data processing unit for handling the received directional information and for showing the direction on the display.

Furthermore, the system pursuant to the invention is characterized by what is disclosed in the claim number ten.

### THE ESSENTIAL IDEA OF THE INVENTION

The essential idea of the invention is that when the direction to a desired point is determined the earth's magnetic field is used as the reference direction, whereby the direction given to the transceiver is compared to the direction of the magnetic field detected by the compass in the transceiver.

Furthermore, the essential idea includes that the method is implemented utilizing the networks generally used for data communication of mobile phones throughout the world. One essential feature related to the invention is also the notion that in order to provide the directional information, the mobile phone user's position data need not necessarily be particularly accurate. For example, if the base station forms several sectorized cells next to one another, it is sufficient to know the phone's distance from the base station and the cell where it is. In this case, the location of the phone in determining the direction to the desired point is the coordinates representing, for instance, the intersecting point of the median direction of the cell and the distance from the base station. In this case, the source of error, in addition to the error in distance measurement, is the difference between phone's actual location and the median direction of the cell. The direction the system in this case gives to the phone user does not deviate from the true direction to an extent that would cause any particular harm, especially over longer distances.

Of course, if an as accurate as possible transceiver positioning method is available, based on either the operation of the network or satellite positioning, or a combination of these, its utilization does not lie outside the scope of the essential idea of this invention.

### BENEFITS OF THE INVENTION

The benefit of the invention is that the possibilities offered by the cellular network of mobile phones are utilized while the direction of the earth's magnetic field is used as the reference direction.

The direction indicating method of the invention is user-friendlier than that of earlier methods and it relies on the operation of a cellular network that already exists as such. For instance, if a person wants to have a mobile phone in any case, he/she can purchase a phone with a direction-indicating feature. Furthermore, the telephone network can provide services enabling the phone user to retrieve information that supports direction indicating.

The invention makes it possible, for instance, to receive the directional information by sending the coordinates of a desired location from a mobile phone to a supplier of such services. The supplier of the service first defines the location of the mobile phone using the known methods and then calculates the direction from that location to the desired location, and then sends a message containing the directional information to the mobile phone., this For instance, the street address that corresponds to the coordinates information contained in the files of the supplier or in the mobile phone's memory could be used instead of coordinates.

Furthermore, it will be easy for the phone user to find the way back to the place where he/she was. In this case, he/she sends the supplier of the service a message requesting them to define the location of the phone and to save the location data. Later, when the phone user wants to return to the same place, he/she asks the supplier for the direction to the location whose data was saved earlier. In this case, saving the location data can be done in the phone's memory or in the computer of the supplier of the service. If the location data is in the phone's memory, the data will be sent to the supplier of the service together with the direction inquiry.

The transceiver can be mobile phone or any other transmitting/receiving device operating in a cellular network. Therefore, various types of transceivers operating in a cellular network can be considered, such as the so-called terminal units, either built-in or detachable, used in vehicles. Later in this application, the term ‘mobile phone’ is for clarity used of the transceiver device, but it is clear that any separate transceiver made for the purpose pursuant to the invention is also within the scope of this invention.

### DRAWINGS

The invention is explained in more detail in the attached drawings, in which

FIG. 1 schematically presents the structure of the cellular network.

FIG. 2 schematically presents a mobile phone pursuant the invention.

FIGS. 3a-3b exemplify the indicating of a direction pursuant to the invention.

FIG. 4 presents a few device applications of the invention.

FIG. 5 presents a further device application of the invention.

FIG. 6 presents a simplified block diagram of the system used for providing directional information to customers on order.

FIG. 7 presents a simplified block diagram of the positioning of a mobile phone in a system pursuant to the invention.

### APPLICATION EXAMPLE

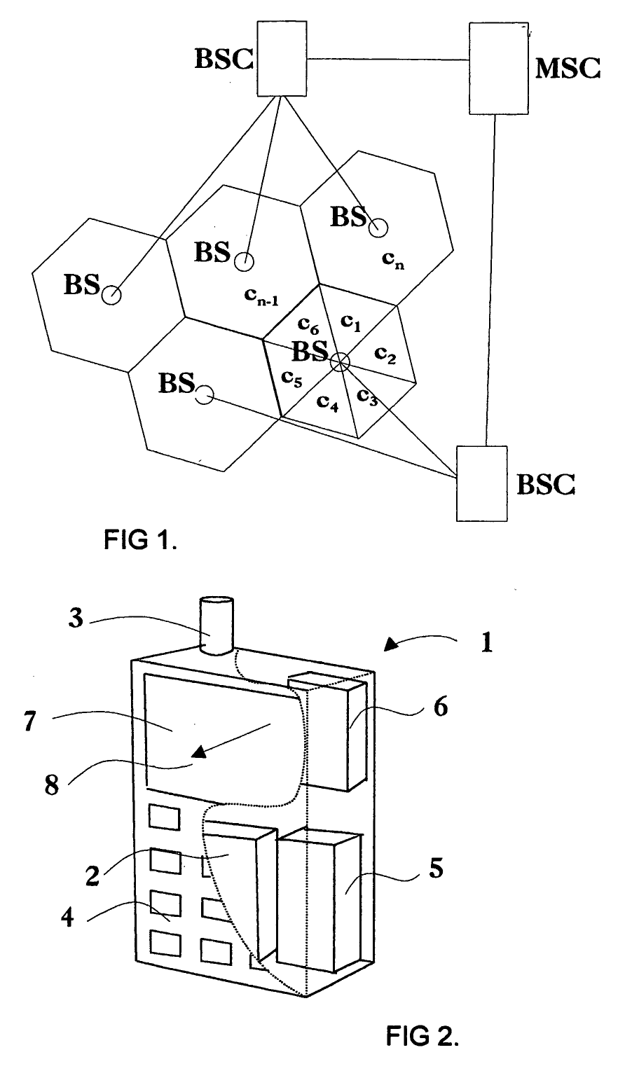

FIG. 1 give a simplified and schematic presentation of the structure of the cellular network. The cellular network is formed of a network of base stations (BS), in which the coverage of a base station may alone form a cell, or the coverage of one base station may consist of several cells (c1-cn). A cell is formed of the transmitter's coverage corresponding to one frequency channel. Depending on the required communication capacity, one base station may have just one radio transmitter and one receiver or several directed radio transmitters and receivers, one for each frequency channel. There are various different applications from different network manufacturers but the main principle of operations in the network relies on the use of base station controllers (BSC) at the base stations connected by mobile services switching centres (MSC). The example in the Figure shows the coverage of a base station as a hexagon representing a theoretical form that can completely cover a certain area. In reality, however, the coverage of each base station depends on a variety of factors of the environment, for instance. In addition, the coverages overlap to a greater or lesser extent enabling the use of, for instance, some of the already mentioned positioning methods relating to the operation of the network.

The tasks of the centres include the management of the operation of the network and the switching of calls. The mobile phone and the base station are constantly measuring the signal with the purpose of supporting the centre or the base station controller in the decision on channel change. The criterion for a channel change can be, for instance, signal strength, the distance of the mobile phone from the base station, or the communication density within the cell.

FIG. 2 schematically presents an example of a partly opened mobile phone (1) pursuant to the invention. It contains the required equipment (2) for exchanging messages with a base station, including, for instance, an antenna (3), and a keypad (4) for typing messages and commands. The mobile phone also incorporates an electronic compass (5), and a data processing unit (6) for handling directional information and showing the direction on the display (7). The mobile phone display (7) is arranged to indicate the direction using, for instance, an arrow (8) or some other convenient means. The data processing unit includes the calculating processor and the required equipment and software for showing the direction on the display.

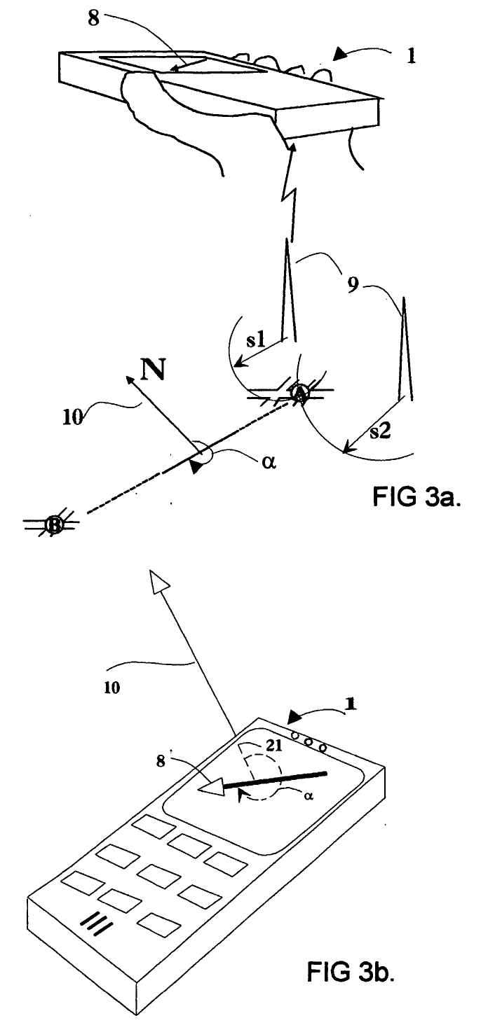

FIG. 3a shows an example of a situation in the network, where a mobile phone pursuant to the invention is used for indicating the direction to a desired location. The desired location can be a location where the mobile phone user was earlier and had the location data in the memory. The desired location can also be, for instance, a restaurant or a theatre whose location data is stored in the memory of either the network system or the mobile phone. In the illustrated example, the mobile phone is in the middle of the city's street system, in location A, from where the phone user wants to reach location B with its location data stored earlier in the memory of either the phone or the network system. The Figure shows the base stations (9) within whose coverage location A exists. The arrow (10) indicates the direction of the earth's magnetic field in the area, with the arrow pointing to the magnetic north (N).

The Figure also shows as an example an enlargement of a mobile phone (1) in a user's hand. The lightning arrow represents the connection to the base station, and the mobile phone display is showing the direction arrow (8).

When desiring directional information, the mobile phone user sends a request to the system. The system first defines the location of the mobile phone using a suitable means available, for instance, distance measurements (s1 and s2) and directional measurements from both of the base stations (9), within whose coverage the mobile phone in location A is. After this, the system defines the direction from the location in question to the desired location, whose location data is at the system's disposal. Pursuant to the invention, the direction is defined in relation to the direction of the earth's magnetic field. In the illustrated situation, the direction from location A to location B is defined as angle α, which is the angle between the direction from A to B and the direction to the magnetic north defined at location A. This calculated direction is sent to the mobile phone, whose data processing unit adds the received direction α to the compass direction of the mobile phone. The resulting direction is shown on the mobile phone's display (7).

FIG. 3b shows the indication of direction on the mobile phone display (7) in more detail. For clarity, the Figure also shows the direction of the earth's magnetic field (10) extending as a dotted line (21) across the display. In the same way, a dotted line shows the angle α that is added to the direction of the magnetic field detected by the device detecting the earth's magnetic field, i.e. to the direction of the magnetic field extended as a dotted line (21) in the illustration. The dotted lined representing the extension of the direction of the magnetic field (21) and the angle α are shown here for clarity only; to better illustrate the operating principle of the invention.

It is impossible to move along straight lines in urban areas. In his case, the mobile phone user has to ask for the direction frequently. The system pursuant to the invention will always give the new direction from any location as many times as necessary.

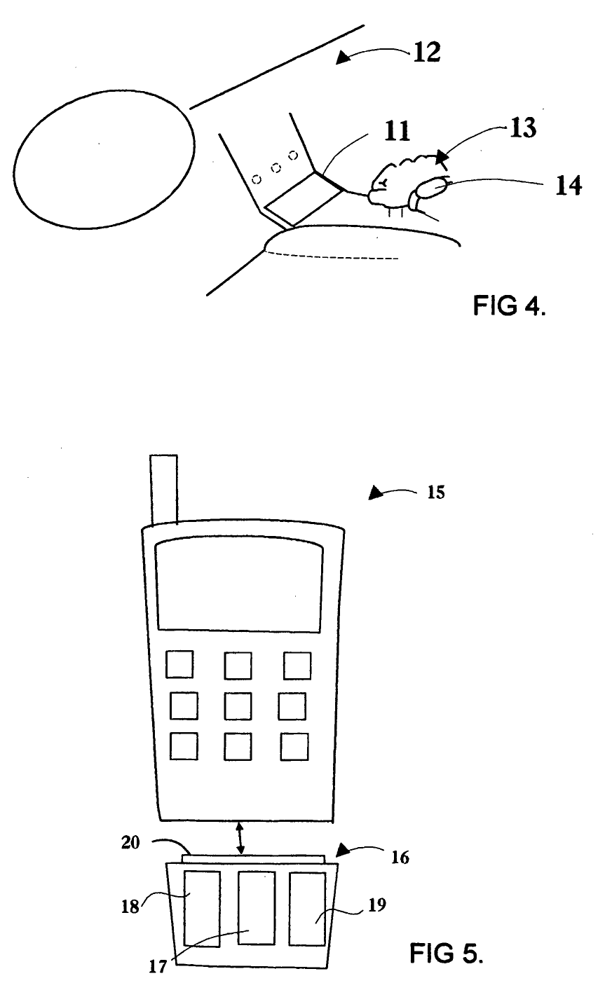

FIG. 4 shows a terminal unit (11) pursuant to the invention operating as a direction-indicating device attached to the instrument panel of a vehicle (12). A device of this type can also be detachable, whereby it can also be used like a portable personal digital assistant (PDA). The Figure also shows the driver's hand (13) with a wrist computer (14) that can operate pursuant to the invention.

FIG. 5 shows an application example of a direction-indicating device pursuant to the invention. The device consists of a mobile phone (15) and an attached module (16) with its internal components shown in the illustration. The module incorporates the devices necessary for implementing the method pursuant to the invention, such as an electronic compass (17), a processing unit for directional data (18), and an electronic memory unit (19). The module can be connected to a mobile phone using a connection (20). The memory may contain, for instance, the names and coordinates of the sights in a large city. Such modules could be rented to tourists, who could attach the module to their mobile phones and use them for conveniently finding their way in the city. The processing unit for directional data, and especially the control unit for displaying the directional information on the display can, of course, be components of the mobile phone.

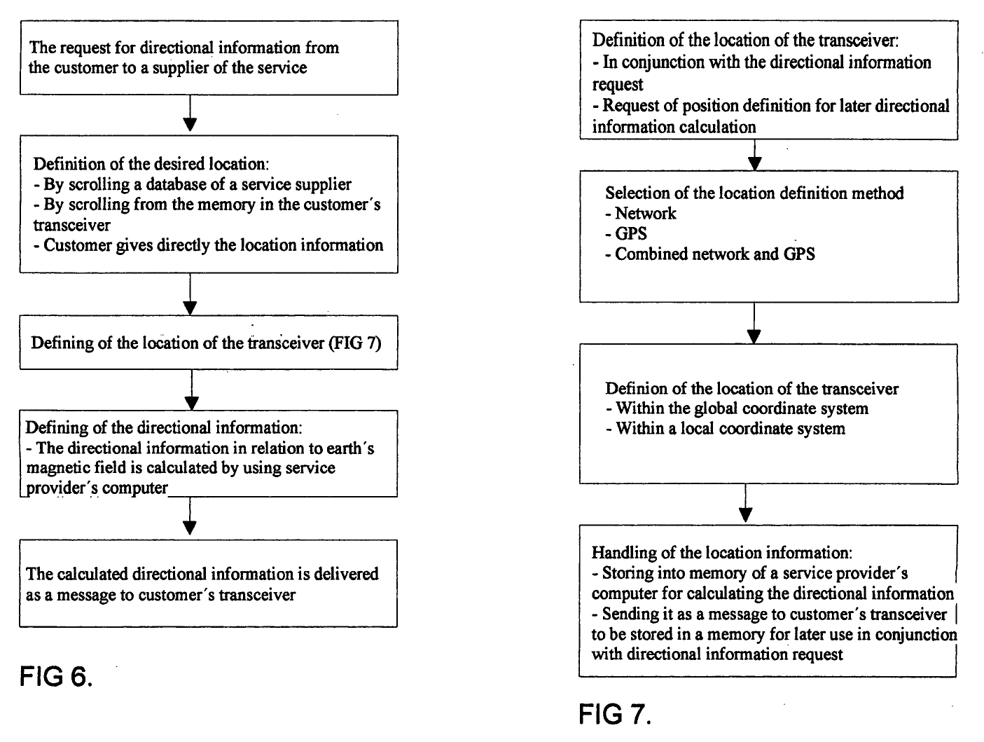

FIG. 6 shows a block diagram of the system by which a mobile phone user is able to receive directional information on his/her mobile phone from a supplier of the service. The operation of the system starts with the request for directional information sent by the customer. The request contains a definition of the desired location. The customer can define the desired location, for instance, by using the mobile phone to access the network and then scrolling a database created for this purpose and containing the names of locations, or by directly giving the coordinates. The memory of the mobile phone may also contain information on locations from which the desired location can be selected in conjunction with the request for directional information. Naturally, the customer may directly give the coordinates of the desired location when sending the request for directional information. To be able to define the directional information to the desired location the system must know the location of the mobile phone from which the request was sent. An example of the defining of the location of a mobile phone is presented in the block diagram in FIG. 7. If the mobile phone in question is provided with GPS or some other equipment suitable for satellite positioning, the location coordinates of the mobile phone may already be included in the message requesting directional information. If satellite positioning is not available, the supplier of the service carries out the positioning of the mobile phone with the existing positioning methods utilizing the network. The combined use of network and satellite positioning is also possible. Positioning can be made within the global coordinate system or, for instance, inside a building within a local coordinate system. Local coordinates can always be connected by calculations to the global coordinate system or converted into coordinates of the global coordinate system by a conversion calculation. When the location coordinates of the mobile phone have been defined, the system stores them into memory for calculating the directional information. When the supplier of the service has the location of the mobile phone where the request for directional information was made, and the coordinates of the desired location, they use a computer to calculate the direction from the defined location of the mobile phone to the desired location in relation to the earth's magnetic field. For the calculation you also need information on the direction of the earth's magnetic field in the defined location of the mobile phone. This direction can be in the above-mentioned database of location data, from which the computer retrieves it in conjunction with the defining of the location of the mobile phone and stores it into memory together with the location data. The direction of the earth's magnetic field at each location can also be defined using the locally defined declination, i.e. the difference between the directions of the magnetic field and the geographical meridian. When the ordered direction to the desired location has been calculated, it will be delivered as a message to the mobile phone that places the request, and that is equipped with a detector for identifying the direction of the earth's magnetic field.

In a system of the kind presented above, all the component operations can be provided by the same company or they can also be provided by different companies so that, for instance, the reception of requests for directional information and the delivery of the directional information to customers, the database with location data, the positioning of mobile phones, and the actual calculation of directional information can all be services provided by different companies. From the customer's point of view, this is insignificant because within the directional information services these component operations constitute a single product for the customer. The general term ‘supplier of service’ used in this application includes the possibility that several different companies may be involved.

The drawings and their explanations are merely intended to illustrate the idea of the invention. In detail, the invention may vary within the limits set by the patent claims.

1. A method for defining the direction to a desired location in a cellular network in which base stations transfer communication and form cells, and in which base stations hold connections within the cell to portable transceivers (1) provided with a display (7) and equipped with a detector (5) that indicates the direction of the earth's magnetic field (10), and with the said method defining the transceivers location within the cellular network area characterized in that the direction to a desired location being calculated as a network service on the basis of the transceiver's defined location in relation to the direction of the earth's magnetic field, and this direction being sent as a message from the base station to the transceiver that, taking account of the transceiver's direction in relation to the direction of the earth's magnetic field and the directional information contained in the sent message, shows the direction to the desired location on the display.

2. A method according to claim 1, characterized in that the given direction to a desired location being given as the angle (α) between the direction of the earth's magnetic field (10) and the direction from the defined location to the desired location.

3. A method according to claims 1 or 2, characterized in that in the transceiver (1) the given direction is added to the direction of the earth's magnetic field defined by the transceiver's detector detecting the direction of the earth's magnetic field (10), and showing this calculated direction with an arrow (8) on the display.

4. A device for indicating the direction to a desired location received as network service in a cellular network, with the said device incorporating at least a display (7) for showing information and equipment for keeping connection to the base station and receiving messages from the base station, as well as a detector for identifying the direction of the earth's magnetic field (10), and characterized in that the said device incorporating at least:
means for sending a directional information request concerning a desired location to a base station
means for processing directional information received from a base station and indicating to the desired location
means for taking into account the direction of the device in relation to the direction of the earth's magnetic field, and
means for showing the direction to a desired location on a display (7).

5. A device according to claim 4 for indicating a direction characterized in that the device is a mobile phone.

6. A device according to claim 4 for indicating a direction characterized in that the device for identifying the direction of the earth's magnetic field is an electronic compass.

7. A device according to claim 4 for indicating a direction characterized in that the device is a terminal unit installed in a vehicle.

8. A device according to claim 4 for indicating a direction characterized in that the device is a wrist computer or a PDA.

9. A device according to claim 4 for indicating a direction characterized in that at least the device for identifying the direction of the earth's magnetic field is contained in a separate module connectable to the said device.

10. A system for defining directional information and for forwarding this information to the customer's transceiver as network service in a cellular network, and with the said system consisting of:
a computer
a memory for storing the location data of desired locations
means for receiving directional information request from a customer
means for receiving location data regarding a customer's transceiver
means for calculating with a computer the direction to a desired point relative to the direction of the earth's magnetic field on the basis of the received location data of transceiver and the location data of the desired location stored in the memory
means for forwarding the calculated directional information to the customer's transceiver as a message in a cellular network.
